(19) United States
(12) Patent Application Publication
(10) Pub. No.: US 2013/0055025 A1
(43) Pub. Date: Feb. 28, 2013

(54) MICROPROCESSOR PROTECTED AGAINST MEMORY DUMP

(71) Applicants: Benoît FEIX, Aubagne (FR); Georges GAGNEROT, Marseille (FR)

(72) Inventors: Benoît FEIX, Aubagne (FR); Georges GAGNEROT, Marseille (FR)

(73) Assignee: INSIDE SECURE, Aix-en-Provence (FR)

(21) Appl. No.: 13/591,656

(22) Filed: Aug. 22, 2012

(30) Foreign Application Priority Data
Aug. 29, 2011 (FR) 11 57603

(51) Int. Cl. G06F 11/28

(52) U.S. Cl. 714/32; 714/E11.178

(57) ABSTRACT

A microprocessor including a memory and a central processing unit configured to sign a binary word written in the memory, and during the reading of a binary word in the memory, verify the signature of the binary word and, if the signature is invalid, launching a protective action of the memory. According to the invention, the central processing unit is configured to execute a write instruction of a binary word accompanied by an invalid signature in a memory zone, so that a later read of the memory zone by the central processing unit launches the protective action.

### BACKGROUND OF THE INVENTION

Embodiments of the present invention relate to a microprocessor including a memory and a central processing unit configured to sign a binary word written in the memory, to verify the signature of a word read in the memory, and to launch a protective action of the memory if the signature is invalid.

As shown in FIG. 1, a conventional microprocessor MP1 generally includes a central processing unit or “CPU” (CPU1) and a memory MEM. Memory MEM may include secret data such as cryptographic keys, security certificates, or the like. The microprocessor is therefore susceptible to attacks by attackers aiming to discover these data, in particular for payment applications (bank cards, pre-paid cards, electronic wallets, or the like).

An attack known as a “memory dump” consists of dynamically modifying, by fault injection or by disturbances, a memory read instruction being executed by the CPU so that the CPU reads a memory zone other than that designated by the instruction or a larger memory zone. It is supposed, for example, that the instruction contains a read address A1 and a parameter L1 indicating the length of a binary string to be read at address A1. The attack may target address A1, parameter L1, or both. The CPU may therefore be led to read a binary string of length L1 at an address A2, a binary string of length L2 at address A1, or even a binary string of length L2 at address A2. The attacker can discover the data present in the considered memory zone by monitoring the data conveyed on a bus. Another type of attack consists of taking control of the CPU by way of a malicious program in order to make it read memory zones containing secret data.

Software countermeasures are generally provided, for example to store parameters A1, L1 of the instruction before it is executed, and to verify, after the instruction has been executed, that the execution address corresponds to address A1 stored and that the length of the string read corresponds to length L1 stored. Another known countermeasure includes executing the read instruction twice and verifying that the same data was read. However, this type of countermeasure does not prevent an attack performed on parameters A1, L1 before they are stored.

Material (hardware) countermeasures are also generally provided. A conventional hardware countermeasure is shown in FIG. 1. The CPU is equipped with a security circuit SCT1. During the write of a word W in memory MEM, circuit SCT1 generates a signature S and concatenates it with word W to form a protected binary string C=W,S. During a memory read, circuit SCT1 verifies the integrity of binary string C. To this end, circuit SCT1 recalculates signature S and compares it with that present in the binary string. If the signature is invalid, circuit SCT1 emits an error signal ER that causes a protective action of the memory.

Signature S often only includes one or several parity bits. For example, for an 8-bit microprocessor, 8-bit words W may be stored in memory with a single parity bit forming signature S. For a 16-bit microprocessor, 16-bit words may be stored with two parity bits forming signature S, each parity bit being associated with a part of the word.

Nevertheless, a parity bit only allows the detection of modifications of an odd number of bits in the word or in the part of the word associated with the parity bit. Thus, the modification of an even number of bits leading to the same parity would not be detected. For example, the following bytes have the same parity: 10000001, 0000011, 10000111, 10011111, and the like.

It may therefore be desired to reinforce the protection against memory dump of a microprocessor including a parity control mechanism, and generally any microprocessor using a signature process that does not provide a complete guarantee that the signed data were not altered.

### BRIEF SUMMARY OF THE INVENTION

Embodiments of the invention relate to a microprocessor including a memory and a central processing unit configured to: during the writing of a binary word in the memory, generate a signature and write the binary word accompanied by the signature in the memory, and during the reading of a binary word in the memory, verify the signature accompanying the binary word and, if the signature is invalid, launching a protective action of the memory, wherein the central processing unit is configured to execute a write instruction of a binary word accompanied by an invalid signature in a memory zone, so that a later read of the memory zone by the central processing unit launches the protective action.

According to one embodiment, the memory is a volatile memory or non volatile memory that is electrically erasable and programmable.

According to one embodiment, the microprocessor includes a security circuit configured to generate a valid signature or an invalid signature on request by the central processing unit.

According to one embodiment, the signature includes at least one parity bit that is partly or entirely a function of bits of the binary word to sign.

Embodiments of the invention also relate to a portable electronic device including an integrated circuit on a semiconductor chip, wherein the integrated circuit includes a microprocessor according to the invention.

Embodiments of the invention also relate to a method of protecting a microprocessor including a memory and a central processing unit, including: during the writing of a binary word in the memory, generate a signature and write the binary word accompanied by the signature in the memory, and during the reading of a binary word in the memory, verify the signature accompanying the binary word and, if the signature is invalid, execute a protective action of the memory, wherein the method further includes writing a binary word accompanied by an invalid signature in a memory zone, such that a later read of the memory zone by the central processing unit launches the protective action.

According to one embodiment, the memory is a read-only memory including a program executable by the central processing unit, and the method includes pre-storing the binary word accompanied by an invalid signature in the memory before the commissioning of the memory.

According to one embodiment, the memory is a volatile or non-volatile electrically erasable and programmable memory, and the method includes using the central processing unit to write the binary word accompanied by an invalid signature in the memory.

According to one embodiment, the method includes a preliminary step of inserting, in a program executed by the central processing unit, at least one write instruction of a binary word accompanied by an invalid signature in the memory.

According to one embodiment, the signature includes at least one parity bit that is partially or entirely a function of bits of the binary word to sign.

According to one embodiment, the protective action includes at least one of the following actions: launching an interruption and executing an error processing program; resetting the central processing unit to zero; erasing all or some of the memory; temporarily or permanently setting the central processing unit out of service; and temporarily or permanently setting all or some of the memory out of service.

Embodiments of the invention also relate to a method of configuring a non-volatile memory program integrated in a microprocessor according to the invention, the method including: designing a program in the form of source code, transforming the program in source code into a program object code executable by a microprocessor, generating signatures and associating them to binary words, and storing the signed object code in the memory, wherein the method further includes inserting at least one binary word accompanied by an invalid signature in a memory zone, so that a later read by the central processing unit of the microprocessor launches a protective action of the memory.

According to one embodiment, the method includes: inserting at least one instruction of a first type in the source code, and when transforming the source code into object code, executing the instruction of the first type by inserting the binary word accompanied by the invalid signature into the object code.

According to one embodiment, the method includes placing the object code in the memory, leaving at least one memory zone empty, generating binary words accompanied by invalid signatures, and placing binary words accompanied by invalid signatures in the empty memory zone.

According to one embodiment, the method includes: inserting at least one instruction of a second type in the source code, and when transforming the source code into object code, transforming the instruction of the second type into an executable write instruction of a binary word accompanied by an invalid signature in the memory.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 previously described, schematically shows a conventional microprocessor,

FIG. 2 schematically shows an embodiment of a microprocessor including a security circuit according to an embodiment of the invention,

FIGS. 3A, 3B respectively show a valid binary string and an invalid binary string,

FIG. 4 schematically shows locations of invalid binary strings in a memory of the microprocessor,

FIG. 5 schematically shows an embodiment of the security circuit,

FIG. 6 shows another embodiment of the security circuit,

FIG. 7 is a flowchart describing a method of inserting invalid binary strings in an executable program,

FIG. 8 is an illustration of the method of FIG. 7,

FIG. 9 shows the general architecture of a portable electronic device including a microprocessor according to an embodiment of the invention.

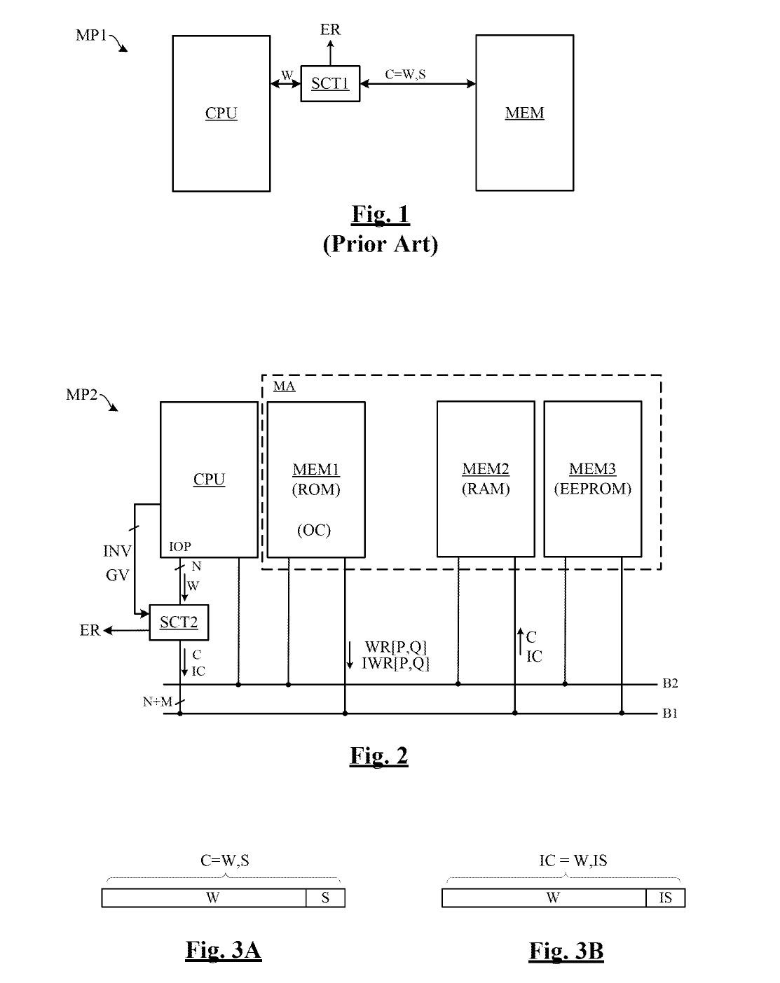

### DETAILED DESCRIPTION OF THE INVENTION

FIG. 2 schematically shows an embodiment of a microprocessor MP2 according to an embodiment of the invention. Microprocessor MP2 includes a central processing unit, hereinafter called “the CPU”, a memory array MA, and a security circuit SCT2. The memory array MA is linked to the CPU by the intermediary of a data and instructions bus B1 and of an address bus B2 (in one implementation variation, the microprocessor may also include distinct data and instruction buses). Memory array MA here includes a read-only memory MEM1 (ROM), a random access memory MEM2 (RAM), and an electrically erasable and programmable memory MEM3, for example of the EEPROM type. Memories MEM1 and MEM3 are non-volatile memories whereas memory MEM2 is a volatile memory.

Memory MEM1 includes a microprocessor-executable program, stored in the memory in the form of object code. This executable program includes several software layers that cooperate. In general, the microprocessor operating system, a hardware abstraction layer controlling the various CPU peripherals and pilots (not shown), and an application layer including one or more application programs, for example bank transaction programs, may be distinguished. Moreover, memories MEM1, MEM2, MEM3 may receive secret data such as certificates, cryptographic keys, session keys, intermediary cryptographic calculation data, transaction data, or the like.

Security circuit SCT2 is configured to generate a signature S of M bits from a binary word W of N bits. During the write of word W in memory array MA, circuit SCT2 concatenates signature S with word W to form a binary string C=W,S of a length of N+M bits that is applied on bus B1 before being written in the memory.

Circuit SCT2 verifies the integrity of the binary string when the CPU reads the binary string C in memory array MA. To this end, circuit SCT2 recalculates signature S from word W contained in the binary string, then compares the re-calculated signature with that present in the binary string. If the signature present in the binary string is invalid, circuit SCT2 emits an error signal ER that causes a protective action of the memory array.

The protective action includes, for example, one or more of the following actions: the launch of an interruption and the execution of an error processing program by the CPU, preferably in a secure mode; the reset of the CPU to zero; the erasure of all or some of memory MEM2 and/or MEM3; the temporary or permanent setting of the CPU out of service; and the temporary or permanent setting of all or some of one or each memory MEM1, MEM2, MEM3 out of service.

According to embodiments of the invention, the CPU is configured to decode and to execute a write instruction IWR[P,Q] of an invalid binary string IC in addition to a conventional write instruction WR[P,Q] of a valid binary string C. As shown in FIG. 3A, a valid binary string C contains a binary word W concatenated with a valid signature S. As shown in FIG. 3B, an invalid binary string IC contains a binary word W concatenated with an invalid signature IS.

Parameters P, Q present in instructions WR and IWR may be of different types, indexed or non indexed, at the choice of the microprocessor designer. For example, parameter P may be the value or the read address of word W to write in the memory, or even an index to a memory address or to a CPU register containing the word to write or the address where the word to write may be found. Similarly, parameter Q may be the write address of the word, or an index to a memory address or to a register containing the write address of the word.

Security circuit SCT2 is configured to generate an invalid signature IS on demand by the CPU, when the CPU executes the special instruction IWR[P,Q]. In this case, circuit SCT2 concatenates binary word W with invalid signature IS and supplies an invalid binary string IC=W,IS, written in memory array MA by the CPU.

The executable program present in memory MEM1 contains at least one and preferably several instructions IWR[P,Q]. The program is conceived so that the CPU sets invalid binary strings IC in memory array MA next to memory zones containing secret data to be protected against a read by memory dump.

Preferably, the designer of the executable program made sure to set an invalid binary string before and/or after a memory zone to protect. Indeed, an attempt to read a secret data by way of a memory dump is never perfectly centered on the sensitive memory zone containing the secret data. Generally, contiguous memory zones placed before and/or after the sensitive memory zone are read. If the contiguous memory zones contain invalid binary strings, an attempt to dump the memory targeting the sensitive memory zone will implicate the read of an invalid binary string. This read will cause security circuit SCT2 to emit error signal ER and the launch of the protective action, which will interrupt the CPU and prevent the memory dump.

Thus, each invalid binary string IC placed in memory array MA forms a sort of “barrier” against memory dump, and is preferably placed before and after a memory zone containing data to protect, and preferably immediately before and immediately after this memory zone.

The designer of the executable program should also make sure that the CPU never reads the memory at addresses where it placed invalid binary strings. These forbidden addresses are thus not susceptible of being read during normal program execution, and are only read after a fault injection or due to a disturbance modifying a read instruction.

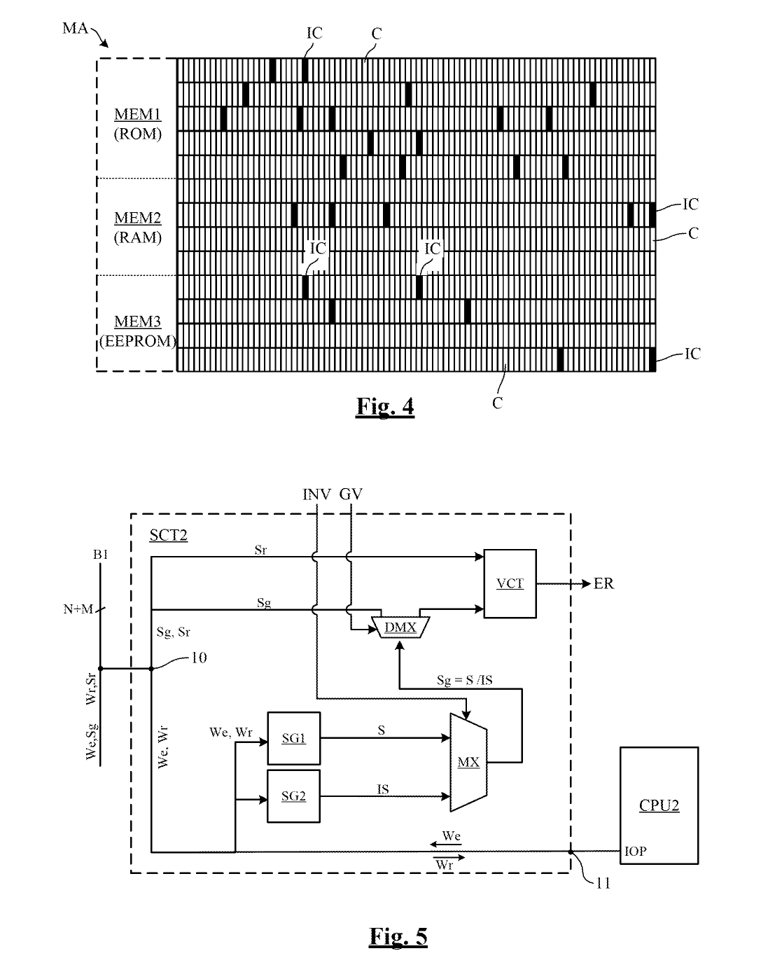

FIG. 4 is a simplified representation of the memory array MA contents. Black rectangles represent invalid binary strings IC. White rectangles represent valid binary strings C. The valid binary strings do not necessarily contain data written by the CPU and may correspond to blank locations (that have not yet received data) including binary strings considered by default by circuit SCT2 as valid binary strings (for example a group of 0's). Invalid binary strings IC in memories MEM2, MEM3 may be distinguished. These invalid binary strings were written by the CPU thanks to instruction IWR. For example, during the execution of a cryptographic calculation requiring a calculation of an intermediary secret variable needing to be stored in memory MEM2 or MEM3, the executable program is designed so that the CPU writes a first invalid binary string immediately before the location of the intermediary secret variable, and a second invalid binary string immediately after the intermediary variable.

FIG. 5 shows an embodiment of security circuit SCT2. Reference “We” designates a binary word W emitted by an input/output port IOP of the CPU and needing to be signed by way of a signature Sg generated by circuit SCT2. Reference “Wr” designates a binary word W read in the memory by the intermediary of bus B1, accompanied by a signature Sr needing to be verified by circuit SCT2.

Circuit SCT2 includes an input/output 10 of N+M bits connected to bus B1 and an input/output 11 of N bits connected to port IOP of the CPU. It also includes a signature circuit SG1 configured to generate a valid signature S of M bits, a signature circuit SG2 configured to generate an invalid signature IS of M bits, a multiplexor MX with two inputs and one output, a demultiplexor DMX with one input and two outputs, and a signature verification circuit VCT. Multiplexor MX is controlled by a signal INV (“Invalid”) and demultiplexor DMX is controlled by a signal GV (“Generate/Verify”). These signals are supplied by the CPU. The inputs and outputs 10, 11 of circuit SCT2 are applied on the inputs of signature circuits SG1, SG2. The outputs of circuits SG1, SG2 are applied to multiplexor MX, the output of which is applied to the input of demultiplexor DMX. A first output of demultiplexor DMX is applied to a first input of signature verification circuit VCT and a second output of demultiplexor DMX is linked to input/output 10 of circuit SCT2, where it is connected to M wires of bus B1 conveying a received signature Sr or a generated signature Sg. The second input of signature verification circuit VCT is linked to input/output 10 of circuit SCT2. The output of signature verification circuit VCT supplies error signal ER.

Circuit SCT2 functions in the following manner (the logical values of signals INV, GV, ER are arbitrary):

i) When the CPU executes an instruction WR[P,Q]:
the CPU executes a pre-decoding or a pre-execution of the instruction until it knows the word We to write in memory array MA and the address where it is to be written,
word We is placed on bus B1 and is found at the inputs of circuits SG1, SG2 which respectively supply a valid signature S and an invalid signature IS,
the CPU applies signal INV=1 to multiplexor MX to select the valid signature Sg (Sg=S) at its output
the CPU applies signal DMX=1 to demultiplexor DMX so that the valid signature Sg is directed towards its second output, connected to bus B1 via input/output 10,
the valid signature (Sg=S) thus finds itself on bus B1, concatenated with word We,
word We and signature Sg are stored in memory array MA.

ii) When the CPU executes an instruction IWR[P,Q]:
the CPU executes a pre-decoding or a pre-execution of the instruction until it knows the word We to write in memory array MA and the address where it is to be written,
word We is placed on bus B1 and is found at the inputs of circuits SG1, SG2, which respectively supply a valid signature S and an invalid signature IS,
the CPU applies signal INV=0 to multiplexor MX to select the invalid signature Sg (Sg=IS) at its output,
the CPU applies signal DMX=1 to demultiplexor DMX so that the invalid signature is directed towards its second output, connected to bus B1 via input/output 10,
the invalid signature Sg thus finds itself on bus B1, concatenated with word We,
word We and invalid signature Sg are stored in memory array MA.

iii) When the CPU executes a read instruction of memory array MA:
the word read Wr accompanied by its signature Sr is placed on bus B1. Word Wr is found at the input of circuits SG1, SG2, which respectively supply a valid signature S and an invalid signature IS. The signature read Sr is found on the second input of signature verification circuit VCT,
the CPU applies signal INV=1 to multiplexor MX to select the valid signature Sg (Sg=S) at its output,
the CPU applies signal DMX=0 to demultiplexor DMX so that signature Sg is directed towards its first output and applied at the first input of signature verification circuit VCT,
verification circuit VCT sets signal ER to 1 (active value) if the received signature Sr is different from signature Sg.

It will be noted that security circuit SCT2 may be integrated in the CPU and may in any case be considered as part of the CPU or an organ thereof. Its representation as a circuit external to the CPU connected to port IOP is thus provided here simply for illustrative purposes. Moreover, circuit SCT2 is susceptible of various embodiments other than a hard-wired circuit. It may also be made in the form of a microprogrammed circuit, a state machine, and in general any implementation form within the reach of the skilled person.

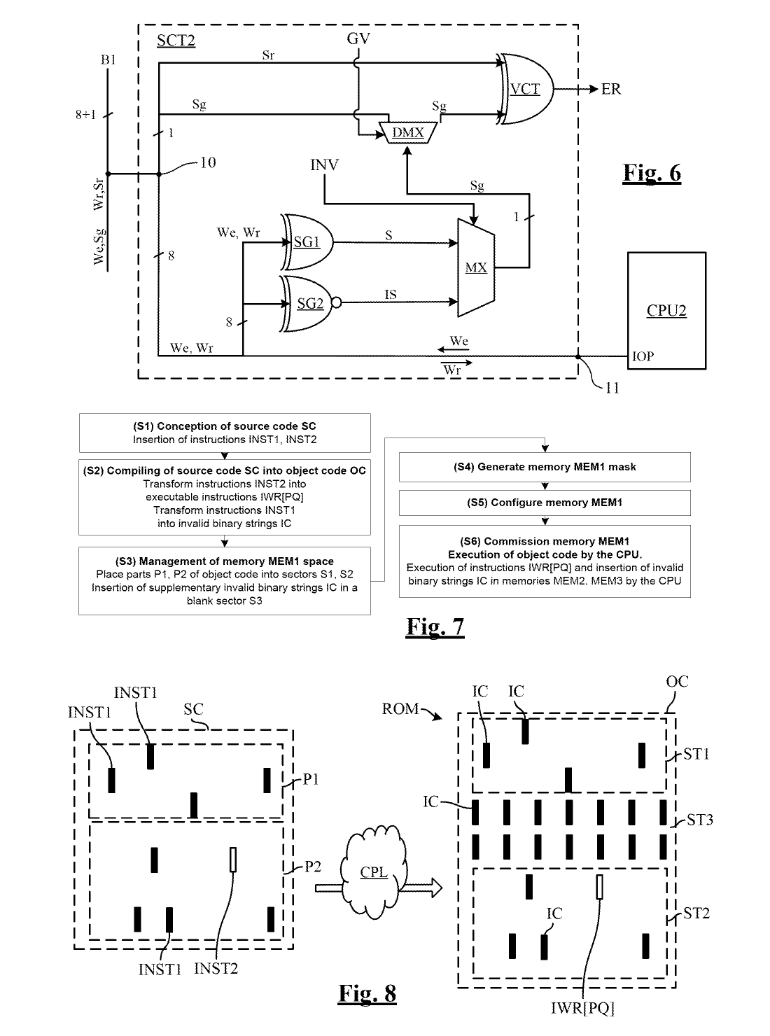

In an embodiment of circuit SGC2 shown in FIG. 6, bus B1 conveys bytes W (8-bit words) and signatures of 1 bit forming a parity bit. Signature circuit SG1 is an exclusive OR gate receiving the 8 bits of a byte W and supplying a parity bit forming signature S. Signature circuit SG2 is a not exclusive OR gate receiving the 8 bits of a byte W and supplying an inverted parity bit forming an invalid signature IS. Signature comparison circuit VCT is an exclusive OR gate including 2*8 inputs to compare the bits two-by-two. In an embodiment not shown, this 16-input exclusive OR gate includes, for example, 8 exclusive OR gates of two inputs each in parallel, arranged to compare two-by-two bits of the same weight of signatures Sg and Sr, and an OR gate grouping the outputs of the 8 exclusive OR gates to supply error signal ER, which goes to 1 if two bits of the same rank have different values.

With reference to FIG. 4 again, invalid binary strings IC situated in read-only memory MEM1 may be distinguished in memory array MA. As it is only read-accessible to the CPU, these invalid binary strings were not placed by the CPU but rather inserted in memory MEM1 when the executable program was stored there. In an embodiment of the invention, invalid binary strings IC are automatically inserted in the executable program during its object code compilation from a source code.

FIG. 7 describes general steps of method of generating the executable program according to the invention and of configuring the read only memory MEM1. FIG. 8 schematically shows this process.

The process includes a step S1 of designing the program with a low-level language, for example in C language. Instructions of a first type INST1 and instructions of a second type INST2 are provided in this program, which forms source code SC. This low-level program may itself be issued by a program written using a high-level language, which was compiled to obtain the source code.

During a step S2, source code SC is compiled to obtain a signed object code OC executable by the CPU. The object code includes instructions and variables provided with signatures S, each instruction or variable forming one or more valid binary strings. During this step, compiler CPL is configured to transform instructions INST1 into invalid binary strings IC inserted in object code OC, and to transform instructions INST2 into executable instructions IWR[PQ] such as described above, being part of the object code and thus forming valid binary strings.

An optional step S3 of memory space management is then provided. This step may be conducted by compiler CPL or by a memory space management program intervening after the compiler. During this step, the object code is distributed throughout different sectors of the space in memory MEM1. In the example shown in FIG. 8, source code SC includes two distinct parts P1, P2, for example the operating system and the hardware abstraction layer on one hand, and application programs on the other hand. A sector ST1 of the available memory space is allocated to part P1 and a sector ST2 of the memory space is allocated to part P2. In doing so, it may happen that a sector ST3 of memory MEM1 is not used, for example a sector situated between sectors ST1 and ST2.

In an embodiment of the method, the compiler or the program in charge of the memory space management is configured to insert supplementary invalid binary strings IC in sector ST3, instead of leaving it blank. Even though sector ST3 does not contain secret data, the invalid binary strings stored therein prevent a memory dump attempt passing through or centered on blank sector S3, and thus offers supplementary protection.

During a step S4, a ROM mask is generated. This mask is a representation of the object code in the form of a semiconductor topography or “layout”, for example in the form of an ensemble of word and bit lines interconnected in a selective manner by transistors.

During a step S5, memory MEM1 is configured by way of the mask.

During a step S6, the memory is commissioned, and the CPU executes the object code that it includes. This execution includes the execution of instructions IWR[PQ] inserted in the object code, which leads the CPU to insert invalid binary strings IC in memory MEM2 or MEM3 in the manner described above.

It will clearly appear to the skilled person that the method that has just been described is not applicable solely to a read only memory. The executable program may also be stored in a program memory of the electrically programmable and erasable type, for example a FLASH memory. In this case, the step of producing the mask is not performed and the object code is directly programmed in the memory program.

Similarly, the write process of invalid binary strings in memories MEM2 and MEM3 disclosed above may be applied to various other types of volatile or non-volatile electrically erasable and programmable memories.

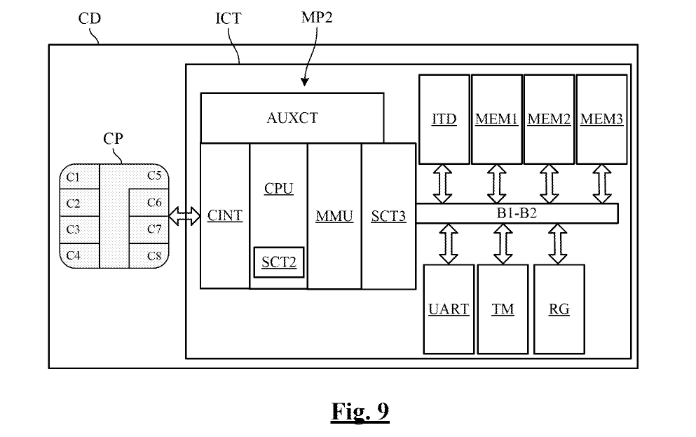

FIG. 9 shows an application example of microprocessor MP2 according to an embodiment of the invention. It includes, besides the CPU and memories MEM1 to MEM3, a communication interface CINT, a memory management unit MMU, a security circuit SCT3, an auxiliary circuitry AUXCT (physical parameter sensors, signal generators, oscillators, or the like), and peripheral elements linked to buses B1, B2. The peripheral elements include for example an interruption decoder ITD, a universal asynchronous receiver/transmitter UART, a timer TM, and a random or pseudo-random number generator RG. Security circuit SCT3 is for example a cryptographic circuit that the CPU uses to encrypt certain data stored in memories MEM2, MEM3 and/or to authenticate itself to a terminal during a transaction.

These elements are embedded in a semiconductor microchip forming an integrated circuit ICT. The integrated circuit is mounted in a plastic card CD equipped with contacts CP, for example ISO7816 contacts, to which communication interface CINT is linked. The ensemble forms a chip card susceptible of various applications. Communication interface CINT can be of the contactless type, equipped with an RF antenna coil or a UHF antenna.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A microprocessor including a memory and a central processing unit configured to:
during the writing of a binary word in the memory, generate a signature and write the binary word accompanied by the signature in the memory, and
during the reading of a binary word in the memory, verify the signature accompanying the binary word and, if the signature is invalid, launching a protective action of the memory,
wherein the central processing unit is configured to execute a write instruction of a binary word accompanied by an invalid signature in a memory zone, so that a later read of the memory zone by the central processing unit launches the protective action.

2. The microprocessor according to claim 1, wherein the memory is a volatile memory or non volatile memory that is electrically erasable and programmable.

3. The microprocessor according to claim 1, including a security circuit configured to generate a valid signature or an invalid signature on request by the central processing unit.

4. The microprocessor according to claim 1, wherein the signature includes at least one parity bit that is partly or entirely a function of bits of the binary word to sign.

5. A portable electronic device including an integrated circuit on a semiconductor chip, wherein the integrated circuit includes a microprocessor according to claim 1.

6. A method of protecting a microprocessor including a memory and a central processing unit, the method comprising:
during the writing of a binary word in the memory, generating a signature and writing the binary word accompanied by the signature in the memory,
during the reading of a binary word in the memory, verifying the signature accompanying the binary word and, if the signature is invalid, executing a protective action of the memory, and
writing a binary word accompanied by an invalid signature in a memory zone, such that a later read of the memory zone by the central processing unit launches the protective action.

7. The method according to claim 6, wherein the memory is a read-only memory including a program executable by the central processing unit, and the method includes pre-storing the binary word accompanied by an invalid signature in the memory before commissioning of the memory.

8. The method according to claim 6, wherein the memory is a volatile or non-volatile electrically erasable and programmable memory, and the method includes using the central processing unit to write the binary word accompanied by an invalid signature in the memory.

9. The method according to claim 8, including a preliminary step of inserting, in a program executed by the central processing unit, at least one write instruction of a binary word accompanied by an invalid signature in the memory.

10. The method according to claim 6, wherein the signature includes at least one parity bit that is partially or entirely a function of bits of the binary word to sign.

11. The method according to claim 6, wherein the protective action includes at least one of the following actions: launching an interruption and executing an error processing program; resetting the central processing unit to zero; erasing all or some of the memory; temporarily or permanently setting the central processing unit out of service; and temporarily or permanently setting all or some of the memory out of service.

12. A method of configuring a non-volatile memory program integrated in a microprocessor according to claim 1, the method comprising:
designing a program in the form of source code,
transforming the program in source code into a program object code executable by a microprocessor,
generating signatures and associating them to binary words,
storing the signed object code in the memory, and
inserting at least one binary word accompanied by an invalid signature in a memory zone, so that a later read by the central processing unit of the microprocessor launches a protective action of the memory.

13. The method according to claim 12, including:
inserting at least one instruction of a first type in the source code, and
when transforming the source code into object code, executing the instruction of the first type by inserting the binary word accompanied by the invalid signature into the object code.

14. The method according to claim 12, including placing the object code in the memory, leaving at least one memory zone empty, generating binary words accompanied by invalid signatures, and placing binary words accompanied by invalid signatures in the empty memory zone.

15. The method according to claim 13, including:
inserting at least one instruction of a second type in the source code, and
when transforming the source code into object code, transforming the instruction of the second type into an executable write instruction of a binary word accompanied by an invalid signature in the memory.
